(19) United States
(12) Patent Application Publication
(10) Pub. No.: US 2013/0042688 A1
(43) Pub. Date: Feb. 21, 2013

(54) PHOTOACOUSTIC IMAGING APPARATUS

(71) Applicants: Shih-Bin Luo, Hsinchu County (TW); Hsiu-Hsiang Chen, Hsinchu County (TW); De-Yi Chiou, New Taipei City (TW); Wan-Ting Tien, Chiayi City (TW)

(72) Inventors: Shih-Bin Luo, Hsinchu County (TW); Hsiu-Hsiang Chen, Hsinchu County (TW); De-Yi Chiou, New Taipei City (TW); Wan-Ting Tien, Chiayi City (TW)

(73) Assignee: INDUSTRIAL TECHNOLOGY RESEARCH INSTITUTE, Hsinchu (TW)

(21) Appl. No.: 13/437,870

(22) Filed: Apr. 2, 2012

(30) Foreign Application Priority Data
Aug. 19, 2011 (TW) 100129761

(51) Int. Cl. G01N 29/00

(52) U.S. Cl. 73/606

(57) ABSTRACT

A photoacoustic imaging apparatus for detecting a photoacoustic image of a detected object is provided. The photoacoustic imaging apparatus includes a laser probe and a transparent ultrasonic sensor. The laser probe is configured to emit a laser beam. The transparent ultrasonic sensor is disposed over the laser probe. The laser beam emitted from the laser probe passes through the transparent ultrasonic sensor to be transmitted to the detected object.

### CROSS-REFERENCE TO RELATED APPLICATION

This application claims the priority benefit of Taiwan application serial no. 100129761, filed on Aug. 19, 2011. The entirety of the above-mentioned patent application is hereby incorporated by reference herein and made a part of this specification.

### BACKGROUND

1. Technical Field

The disclosure relates to a sensing apparatus and particularly relates to a photoacoustic imaging apparatus.

2. Related Art

When an organism (e.g. a living organism) is irradiated by a light, the organism absorbs the light energy and converts a portion of the light energy into acoustic energy, which is spread in the form of acoustic wave. This effect is called a photoacoustic effect. The photoacoustic effect is usually applied to inner imaging of a living organism or chemical examination of an analyzed object. A photoacoustic imaging probe utilizes the photoacoustic effect to determine the image characteristics of a certain area of the living organism, and in general the photoacoustic imaging probe at least includes an ultrasonic transducer and a light source. After a section of the living organism is irradiated by light, a photoacoustic wave signal is generated and spread out, and the provided ultrasonic transducer can receive the signal to determine the image characteristics.

Generally the ultrasonic transducer and the light source of the detected area are preferably disposed as closer to each other as possible. And, the ultrasonic transducer and the light source are usually coupled on the same surface region. However, the ultrasonic transducer cannot be disposed over the region where the light source is located, and as a result, the photoacoustic wave signal cannot be detected and a blind spot occurs. Generally the blind spot would impair the sensitivity of the ultrasonic transducer. In order to reduce the influence the blind spot causes to the sensitivity of the ultrasonic transducer, an aperture for output of the light source is formed as small as possible. However, the small aperture is more difficult to fabricate. To solve the problem, it is necessary to provide a suitable and stable irradiation function on the photoacoustic imaging probe and a light source having a large area and uniform intensity.

When a conventional photoacoustic imaging probe is operated, reflective mirrors positioned at two sides of the ultrasonic transducer are used to change the direction of the laser beam. When detecting the photoacoustic wave signal at a different depth of the organism, the reflective mirrors need to be turned to change the depth that the laser beam irradiates in the detected area of the ultrasonic transducer. Such an operation however is not time-efficient and cannot efficiently use the energy of the laser.

### SUMMARY

According to an exemplary embodiment of the disclosure, a photoacoustic imaging apparatus is provided for detecting a photoacoustic image of a detected object. The photoacoustic imaging apparatus comprises a laser probe and a transparent ultrasonic sensor. The laser probe is configured to emit a laser beam. The transparent ultrasonic sensor is disposed over the laser probe, and the laser beam emitted from the laser probe passes through the transparent ultrasonic sensor to be transmitted to the detected object.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic perspective view of a photoacoustic imaging apparatus according to an exemplary embodiment of the disclosure.

FIG. 2 illustrates the use of a laser probe and a transparent ultrasonic sensor of FIG. 1.

FIG. 3 is a schematic perspective view of the laser probe and the transparent ultrasonic sensor of FIG. 2.

FIG. 4 illustrates an overlap of an irradiation range of a laser beam generated by the photoacoustic imaging apparatus and a sensing range of the transparent ultrasonic sensor of FIG. 1.

FIG. 5 provides schematic cross-sectional views of the photoacoustic imaging apparatus of FIG. 1 from two different directions.

FIG. 6 is a partial schematic cross-sectional view of the photoacoustic imaging probe of FIG. 1.

FIG. 7 and FIG. 8 are front views of photoacoustic imaging probes according to two other exemplary embodiments of the disclosure.

### DETAILED DESCRIPTION

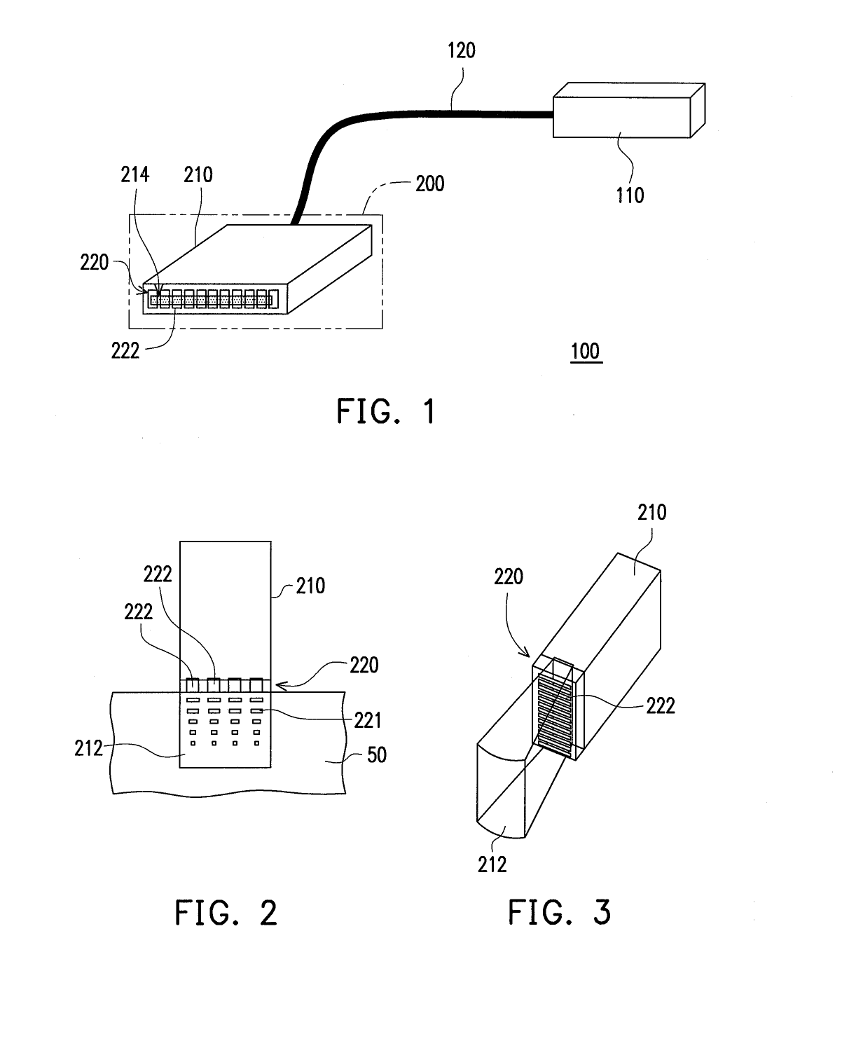

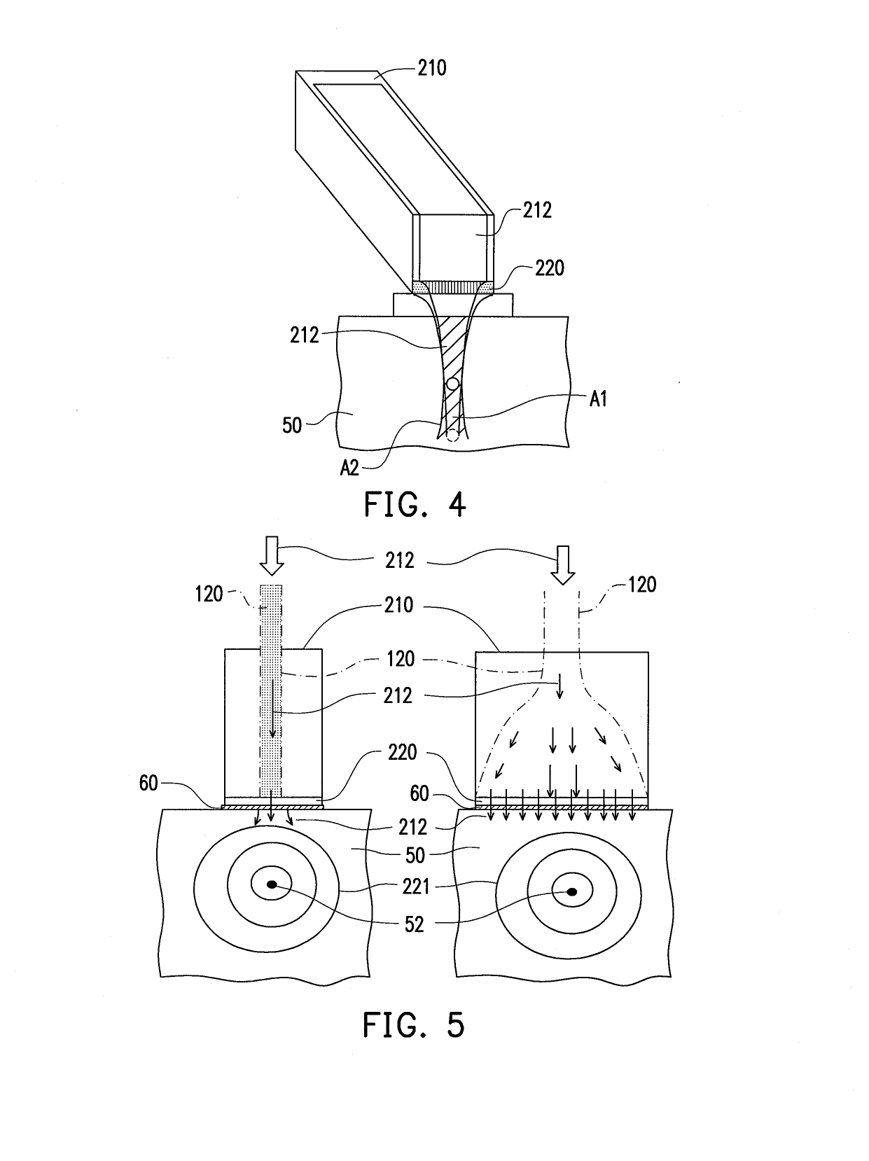

FIG. 1 is a schematic perspective view of a photoacoustic imaging apparatus according to an exemplary embodiment of the disclosure; FIG. 2 illustrates the use of a laser probe and a transparent ultrasonic sensor of FIG. 1; FIG. 3 is a schematic perspective view of the laser probe and the transparent ultrasonic sensor of FIG. 2; and FIG. 4 illustrates an overlap of an irradiation range of a laser beam generated by the photoacoustic imaging apparatus and a sensing range of the transparent ultrasonic sensor of FIG. 1. Referring to FIGS. 1˜4, a photoacoustic imaging apparatus 100 of this embodiment is used for detecting a photoacoustic image of a detected object 50. In this embodiment, the detected object 50 is a tissue of a living organism or a tissue of other organisms or a non-organism. For example, the detected object 50 is a skin of a human body.

The photoacoustic imaging apparatus 100 comprises a laser probe 210 and a transparent ultrasonic sensor 220. The laser probe 210 is configured to emit a laser beam 212. The transparent ultrasonic sensor 220 is disposed over the laser probe 210, and the laser beam 212 emitted from the laser probe 210 passes through the transparent ultrasonic sensor 220 to be transmitted to the detected object 50. In this embodiment, the detected object 50 generates an ultrasonic wave 221 after being irradiated by the laser beam 212. The transparent ultrasonic sensor 220 is configured to detect the ultrasonic wave 221. In this embodiment, the transparent ultrasonic sensor 220 is an ultrasonic transducer, which converts acoustic energy of the ultrasonic wave 221 into electric power. Moreover, in this embodiment, the laser beam 212 is a pulsed laser beam. When the detected object 50 is irradiated by the laser beam 212, the detected object 50 absorbs the pulsed laser beam and a structure of the detected object 50 expands and shrinks due to the variation of thermal energy generated by the pulsed laser beam, thereby generating the ultrasonic wave.

In this embodiment, the transparent ultrasonic sensor 220 is transparent relative to the laser beam 212. Therefore, the laser beam 212 passes through the transparent ultrasonic sensor 220 and is transmitted to the detected object 50. The laser probe 210 emits the laser beam 212 along a sensing range A2 of the transparent ultrasonic sensor 220. That is to say, as shown in FIG. 4, an irradiation range A1 of the laser beam 212 on the detected object 50 and a sensing range A2 of the transparent ultrasonic sensor 220 approximately coincide with each other. Accordingly, the sensing range A2 of the transparent ultrasonic sensor 220 is mostly irradiated by the laser beam 212, and as a result, the transparent ultrasonic sensor 220 obtains a complete photoacoustic wave image signal (i.e. an ultrasonic image generated by the ultrasonic wave 221) with no blind spot. Furthermore, because the sensing range A2 is mostly irradiated by the laser beam 212, unlike the conventional photoacoustic imaging probe, the photoacoustic imaging apparatus 100 of this embodiment is not required to move reflective mirrors to change a depth that the laser beam irradiates in the sensing range of the ultrasonic sensor. In other words, the photoacoustic imaging apparatus 100 of this embodiment utilizes energy of the laser beam 212 sufficiently to generate a photoacoustic wave, and thus the photoacoustic imaging apparatus 100 is used more efficiently. Moreover, because the transparent ultrasonic sensor 220 is disposed over the laser probe 210, the photoacoustic imaging apparatus 100 of this embodiment has a simpler structure and smaller size.

According to this embodiment, the photoacoustic imaging apparatus 100 further comprises a laser generator 110 and an optical fiber bundle 120. The laser generator 110 is configured to provide the laser beam 212. The optical fiber bundle 120 connects the laser generator 110 and the laser probe 210 to transmit the laser beam 212 from the laser generator 110 to the laser probe 210. More specifically, the laser beam 212 generated by the laser generator 110 enters the optical fiber bundle 120 and is transmitted in the optical fiber bundle 120 to the laser probe 210. In this embodiment, the laser probe 210 and the transparent ultrasonic sensor 220 constitute a photoacoustic imaging probe 200.

In this embodiment, the laser probe 210 comprises a light-emitting aperture 214, and the laser beam 212 in the laser probe 210 is transmitted to the transparent ultrasonic sensor 220 via the light-emitting aperture 214. The transparent ultrasonic sensor 220 is disposed over the light-emitting aperture 214, and a shape of the transparent ultrasonic sensor 220 conforms to a shape of the light-emitting aperture 214. To be more specific, in this embodiment, the light-emitting aperture 214 is a linear aperture. In addition, in this embodiment, the transparent ultrasonic sensor 220 comprises a plurality of transparent ultrasonic sensing units 222, which are arranged linearly. Accordingly, the sensing range A2 of the transparent ultrasonic sensor 220 is a sensing plane that extends vertically into the detected object 50, and the irradiation range A1 of the laser beam 212 is also an irradiation plane vertically extending into the detected object 50.

FIG. 5 provides schematic cross-sectional views of the photoacoustic imaging apparatus of FIG. 1 from two different directions. Referring to FIGS. 1, 2, and 5, on the left side of FIG. 5 is a cross-sectional view perpendicular to the light-emitting aperture 214 (i.e. linear aperture), and on the right side of FIG. 5 is a cross-sectional view parallel to the light-emitting aperture 214. According to FIG. 5, the optical fiber bundle 120 passes through the laser probe 210 and extends to the light-emitting aperture 214. Optical fibers of the optical fiber bundle 120 are spread in an extending direction of the light-emitting aperture 214 (i.e. linear aperture). Moreover, in order to favorably transmit the ultrasonic wave 221, which is generated after a light absorber 52 of the detected object 50 absorbs the laser beam 212, to the transparent ultrasonic sensor 220, a layer of a sound wave impedance matching material 60 is applied between the transparent ultrasonic sensor 220 and the detected object 50 for facilitating the transmission of the ultrasonic wave 221.

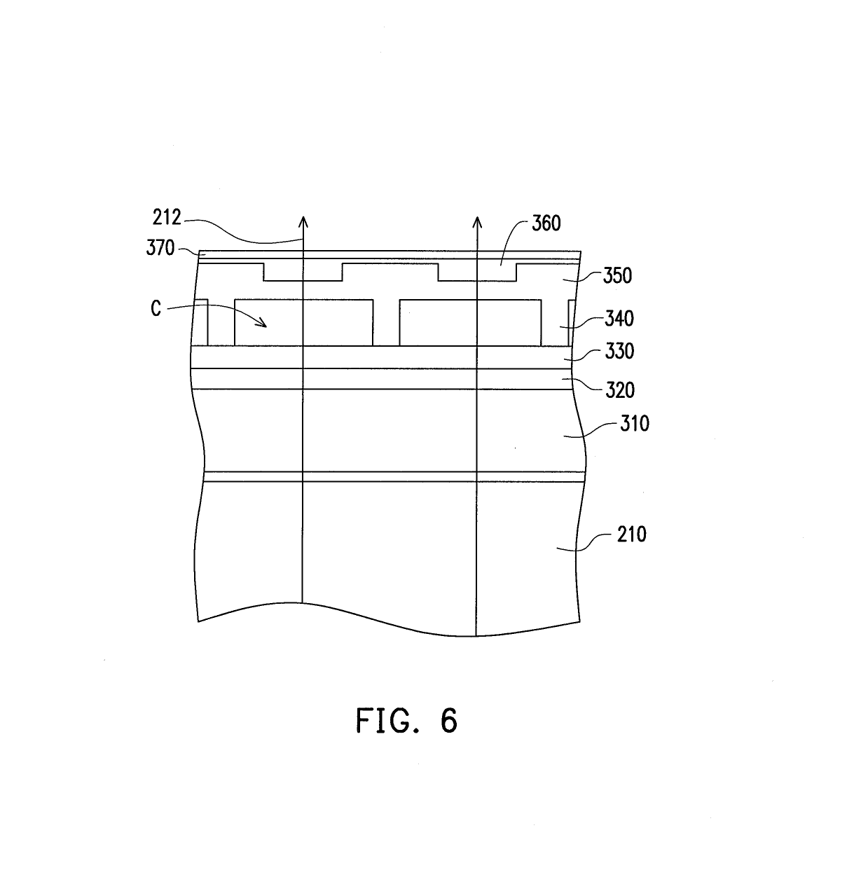

FIG. 6 is a partial schematic cross-sectional view of the photoacoustic imaging probe of FIG. 1. With reference to FIGS. 1, 4, and 6, in this embodiment, a wavelength of the laser beam 212 is in a range of 10˜2400 nanometers. Moreover, in this embodiment, a transmittance of the transparent ultrasonic sensor 220 relative to the laser beam 212 is larger than 60%. That is to say, in this embodiment, the transmittance of the transparent ultrasonic sensor 220 to light having a wavelength ranging from 10 to 2400 nanometers is larger than 60%. Further, in this embodiment, each of the transparent ultrasonic sensing units 222 comprises a transparent substrate 310, a first transparent electrode 320, a transparent insulating layer 330, a patterned transparent support structure 340, a transparent thin film 350, and a second transparent electrode 360. The first transparent electrode 320 is disposed over the transparent substrate 310; the transparent insulating layer 330 is disposed over the first transparent electrode 320; the patterned transparent support structure 340 is disposed over the transparent insulating layer 330; and the transparent thin film 350 is disposed over the patterned transparent support structure 340. At least a cavity C is formed among the transparent insulating layer 330, the patterned transparent support structure 340, and the transparent thin film 350 (a plurality of cavities C is illustrated in this embodiment as an example). The cavity C may be filled with air or a suitable gas. In addition, the second transparent electrode 360 is disposed over the transparent thin film 350. When the ultrasonic wave 221 reaches the transparent ultrasonic sensing units 222, the transparent thin film 350 of the transparent ultrasonic sensing units 222 is vibrated. The first transparent electrode 320 and the second transparent electrode 360 sense the vibration of the transparent thin film 350 and generate an electrical signal. Based on the above, the transparent ultrasonic sensing units 222 convert the ultrasonic wave 221 into the electrical signal.

In this embodiment, the transparent substrate 310 is disposed between the laser probe 210 and the first transparent electrode 320. In other words, the side of the transparent ultrasonic sensing unit 222 on which the transparent substrate 310 is located faces the laser probe 210, and thereby the transparent thin film 350 has enhanced sensitivity for sensing the ultrasonic wave 221. Additionally, in this embodiment, the transparent thin film 350 and the patterned transparent support structure 340 are adapted for light having a wavelength of 10˜2400 nanometers to pass through. Specifically, a material of the transparent thin film 350 and the patterned transparent support structure 340 comprises at least one of a polymer material, silicon (Si), quartz (SiO₂), silicon nitride (Si₃N₄), Al₂O₃, a single crystal material, and other materials that allow light having the wavelength of 10˜2400 nanometers to pass through. The aforementioned polymer material comprises at least one of benzocyclobutene (BCB), polyimide (PI), epoxy photoresist SUB, polydimethylsiloxane (PDMS), and other suitable polymer materials.

Further, in this embodiment, a material of the first transparent electrode 320 and the second transparent electrode 360 comprises at least one of indium tin oxide and indium zinc oxide. In this embodiment, the transparent substrate 310 is a glass substrate or a polymer-based flexible substrate.

In this embodiment, each of the transparent ultrasonic sensing units 222 further comprises a transparent protection layer 370, disposed over the second transparent electrode 360 to protect the second transparent electrode 360.

In the following paragraphs, optical simulation data is provided to verify the transmittance of the transparent ultrasonic sensing units 222. However, the following should not be construed as limitations to the disclosure. With reference to these exemplary embodiments, persons skilled in the art may make proper modifications to the parameters of the aforementioned films/layers without departing from the scope or spirit of the disclosure.

In this optical simulation, a BK7 optical glass having a thickness of 500 micrometers is used as the transparent substrate 310; an indium tin oxide film having a thickness of 0.1 micrometer is used as the first transparent electrode 320 and the second transparent electrode 360 respectively; the cavity C is filled with an air having a thickness of 1 micrometer; a dielectric layer (e.g. a SiO₂ film) having a thickness of 1 micrometer is used as the transparent thin film 350; and a dielectric layer (e.g. a polyimide film) having a thickness of 0.1 micrometer is used as the transparent protection layer 370. The BK7 optical glass adopted in this optical simulation has a refractive index of 1.51184 and an extinction coefficient of 0. A refractive index of the indium tin oxide film is 1.88, and an absolute value of an extinction coefficient of the indium tin oxide film is 0.0056. A refractive index of the air is 1, and an extinction coefficient of the air is 0. A refractive index of SiO₂ is 1.454, and an extinction coefficient of SiO₂ is 0. A refractive index of polyimide is 1.65, and an absolute value of an extinction coefficient of polyimide is 0.0056. In the optical simulation carried out based on the foregoing parameters, a light transmittance of the transparent ultrasonic sensing units 222 is 76.399%, which verifies that the transparent ultrasonic sensing units 222 of the embodiment have high transmittance.

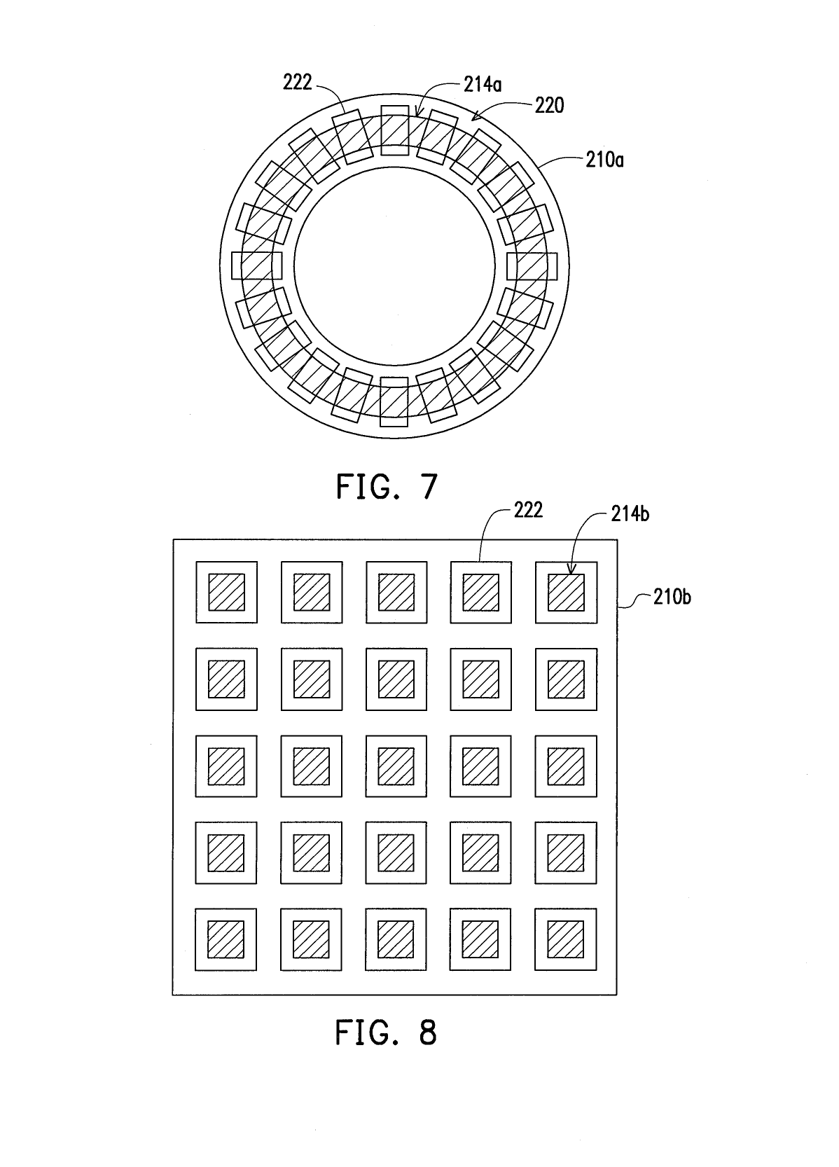

FIG. 7 and FIG. 8 are front views of photoacoustic imaging probes according to two other exemplary embodiments of the disclosure. First, referring to FIG. 7, a photoacoustic imaging probe of this embodiment is similar to the photoacoustic imaging probe 200 shown in FIG. 1. The differences therebetween lie in that a light-emitting aperture 214a of a laser probe 210a of this embodiment is an annular aperture and the transparent ultrasonic sensing units 222 of this embodiment are arranged annularly. Accordingly, in this embodiment, a sensing range of the transparent ultrasonic sensing units 222 is cylindrical, and an irradiation range of the laser probe 210a is cylindrical as well. Next, referring to FIG. 8, a photoacoustic imaging probe of this embodiment is similar to the photoacoustic imaging probe 200 shown in FIG. 1. The differences therebetween lie in that a light-emitting aperture 214b of a laser probe 210b of this embodiment is an array-shaped aperture and the transparent ultrasonic sensing units 222 of this embodiment are arranged in array. Accordingly, in this embodiment, a sensing range of the transparent ultrasonic sensing units 222 is a three-dimensional space and an irradiation range of the laser probe 210b is also a three-dimensional space. Thus, a three-dimensional photoacoustic image can be sensed.

However, the shape of the light-emitting aperture and the arrangement of the transparent ultrasonic sensing units 222 of the disclosure are not limited to the above. In other embodiments of the disclosure, the shape of the light-emitting aperture and the arrangement of the transparent ultrasonic sensing units 222 can have other suitable relationships, such that the sensing range of the transparent ultrasonic sensing units 222 approximately coincides with the irradiation range of the laser beam.

To conclude, in the photoacoustic imaging apparatus of the embodiments of the disclosure, because the transparent ultrasonic sensor is transparent relative to the laser beam, the laser beam passes through the transparent ultrasonic sensor and is transmitted to the detected object. Accordingly, the irradiation range of the laser beam on the detected object and the sensing range of the transparent ultrasonic sensor approximately coincide with each other. The sensing range of the transparent ultrasonic sensor is mostly irradiated by the laser beam, and as a result, the transparent ultrasonic sensor obtains the complete photoacoustic wave image signal with no blind spot. Furthermore, because the sensing range is mostly irradiated by the laser beam, unlike the conventional photoacoustic imaging probe, the photoacoustic imaging apparatus of the embodiments of the disclosure is not required to move reflective mirrors to change the depth that the laser beam irradiates in the sensing range of the ultrasonic sensor. In other words, the photoacoustic imaging apparatus of the embodiments of the disclosure utilizes the energy of the laser beam sufficiently to generate the photoacoustic wave, and thus the photoacoustic imaging apparatus is used more efficiently. In addition, because the transparent ultrasonic sensor is disposed over the laser probe, the photoacoustic imaging apparatus of the embodiments of the disclosure has a simpler structure and smaller size.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A photoacoustic imaging apparatus for detecting a photoacoustic image of a detected object, the photoacoustic imaging apparatus comprising:
a laser probe configured to emit a laser beam; and
a transparent ultrasonic sensor disposed over the laser probe, wherein the laser beam emitted from the laser probe passes through the transparent ultrasonic sensor to be transmitted to the detected object.

2. The photoacoustic imaging apparatus according to claim 1, wherein the detected object generates an ultrasonic wave after being irradiated by the laser beam, the transparent ultrasonic sensor is configured to detect the ultrasonic wave, and the laser probe emits the laser beam along a sensing range of the transparent ultrasonic sensor.

3. The photoacoustic imaging apparatus according to claim 1, wherein a wavelength of the laser beam is in a range of 10˜2400 nanometers.

4. The photoacoustic imaging apparatus according to claim 1, wherein the laser probe comprises a light-emitting aperture, through which the laser beam is transmitted to the transparent ultrasonic sensor disposed over the light-emitting aperture, and a shape of the transparent ultrasonic sensor corresponds to a shape of the light-emitting aperture.

5. The photoacoustic imaging apparatus according to claim 4, wherein the light-emitting aperture is a linear aperture, an annular aperture, or an array-shaped aperture.

6. The photoacoustic imaging apparatus according to claim 4, wherein the transparent ultrasonic sensor comprises a plurality of transparent ultrasonic sensing units, which are arranged linearly, annularly, or in array.

7. The photoacoustic imaging apparatus according to claim 1, wherein a transmittance of the transparent ultrasonic sensor relative to the laser beam is larger than 60%.

8. The photoacoustic imaging apparatus according to claim 1, further comprising:
a laser generator configured to provide the laser beam; and
an optical fiber bundle connecting the laser generator and the laser probe to transmit the laser beam from the laser generator to the laser probe.

9. The photoacoustic imaging apparatus according to claim 1, wherein the transparent ultrasonic sensor comprises a plurality of transparent ultrasonic sensing units, and each of the transparent ultrasonic sensing units comprises:
a transparent substrate;
a first transparent electrode, disposed over the transparent substrate;
a transparent insulating layer, disposed over the first transparent electrode;
a patterned transparent support structure, disposed over the transparent insulating layer;
a transparent thin film, disposed over the patterned transparent support structure, wherein at least a cavity is formed between the transparent insulating layer, the patterned transparent support structure, and the transparent thin film; and
a second transparent electrode, disposed over the transparent thin film.

10. The photoacoustic imaging apparatus according to claim 9, wherein the transparent substrate is disposed between the laser probe and the first transparent electrode.

11. The photoacoustic imaging apparatus according to claim 9, wherein the transparent thin film and the patterned transparent support structure are configured to be passed through by a light having a wavelength ranging from 10 nanometers to 2400 nanometers.

12. The photoacoustic imaging apparatus according to claim 9, wherein a material of the transparent thin film and the patterned transparent support structure comprises at least one of a polymer material, silicon, quartz, silicon nitride, Al₂O₃, and a single crystal material.

13. The photoacoustic imaging apparatus according to claim 9, wherein a material of the first transparent electrode and the second transparent electrode comprises at lease one of indium tin oxide and indium zinc oxide.

14. The photoacoustic imaging apparatus according to claim 9, wherein the transparent substrate is a glass substrate or a polymer-based flexible substrate.

15. The photoacoustic imaging apparatus according to claim 1, wherein the laser beam is a pulsed laser beam.
